(19) United States
(12) Patent Application Publication
(10) Pub. No.: US 2002/0152777 A1
(43) Pub. Date: Oct. 24, 2002

(54) Lockable restrainer for a gearshift lever formed with at least one button

(76) Inventor: Miko Lee, Hsin Chuang City (TW)

Correspondence Address: DELLETT AND WALTERS, 310 S.W. FOURTH AVENUE, SUITE 1101, PORTLAND, OR, 97204, US

(21) Appl. No.: 09/840,790

(22) Filed: Apr. 23, 2001

(51) Int. Cl. G05G 5/00; F16H 57/00

(52) U.S. Cl. 70/202

(57) ABSTRACT

The present invention is related to a lockable restrainer for a gearshift lever formed with at least one button. The lockable restrainer includes a helmet formed by a pair of rigid sidewalls, a rigid convex rear wall, a rigid top wall, a bottom opening and a front opening. The helmet defines therein a chamber that has a convex portion behind the rear wall, and the convex portion of the chamber is dimensioned to receive the button of the gearshift lever. A door is pivotally connected to the helmet for opening and closing the front opening. Furthermore, the door is formed with a lock for releasably fastening the door to the helmet after the front opening has been fully closed.

### BACKGROUND OF THE INVENTION

1. Field of the Invention

The present invention relates to a lockable restrainer for a gearshift lever formed with at least one button and, more particularly, to such a lockable restrainer which takes up a small space within an automobile.

2. Description of Related Art

Thousands of vehicles, such as cars or trucks, are stolen every day in the world in spite of the door locks they are provided with. Various lockable restrainers are now in wide use as an additional means to prevent anyone other than the authorized user from driving the vehicle. These lockable restrainers are generally configured either as shackles that fasten the steering wheels, or as fetters that fasten the gearshift levers to the emergency brakes

Irrespective of the configurations, the conventional restrainers share a common problem in that each of them is too long and so takes up a lotof space within the automobile.

Therefore, it is an objective of the invention to provide a lockable restrainer for a gearshift lever to mitigate and/or obviate the aforementioned problem.

### SUMMARY OF THE INVENTION

The object of the present invention is to provide a lockable restrainer which is used for a gearshift lever formed with at least one button and which takes up small space within an automobile.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a lockable restrainer in accordance with the present invention for a gearshift lever formed with buttons at a side thereof;

FIG. 2 is an exploded perspective view of the lockable restrainer shown in FIG. 1;

FIG. 3 is a cross-sectional view showing the lockable restrainer of FIG. 1 covering the buttons of the gearshift lever;

FIG. 4 is a fragmentary cross-sectional view showing the restrainer of FIG. 1 in an unlocked position; and

FIG. 5 is a fragmentary cross-sectional view showing the restrainer of FIG. 1 in a locked position.

### DETAILED DESCRIPTION OF THE PREFERRED EMBODIMENT

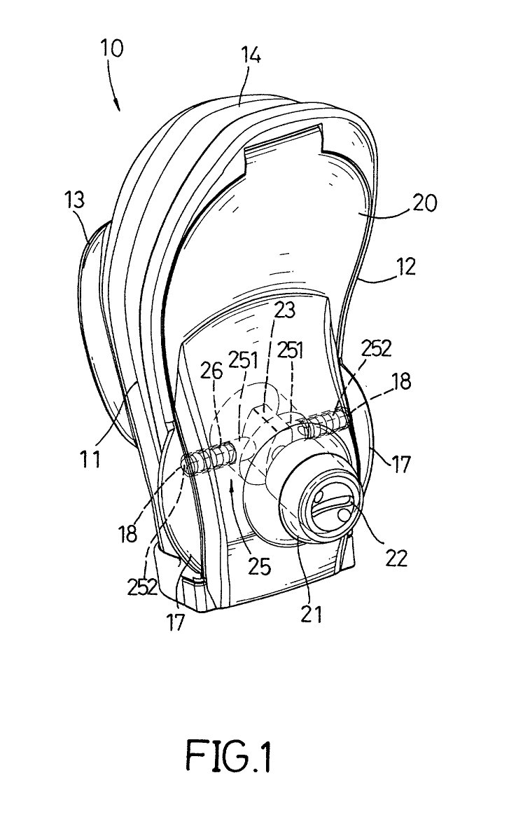

Referring to FIG. 1, a lockable restrainer in accordance with the present invention includes a helmet (10) formed with a movable door (20). The helmet (10) has a pair of rigid sidewalls (11,12), a rigid convex rear wall (13) and a rigid top wall (14), and so defines therein a chamber that has a convex portion behind the rear wall (13).

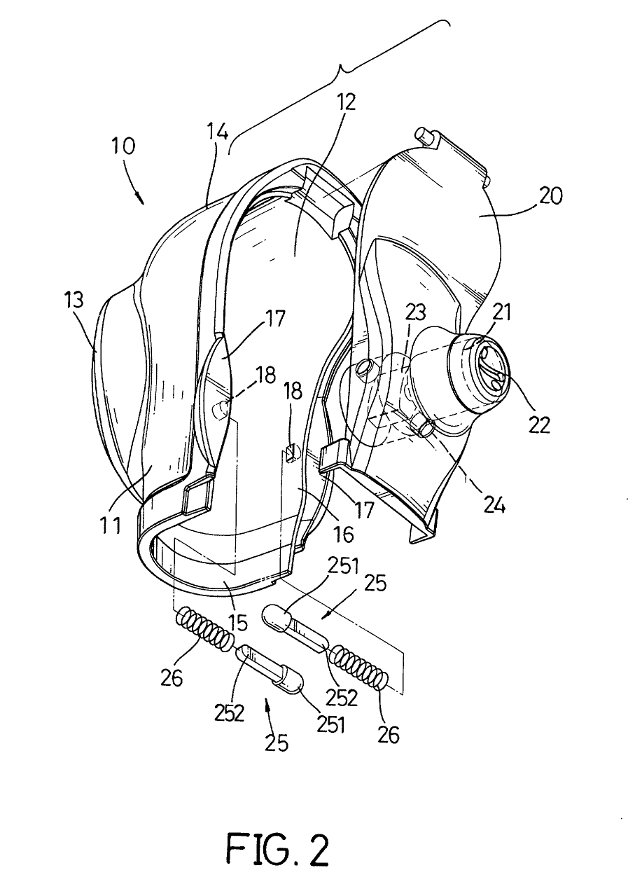

Referring to FIG. 2, the helmet (10) further has a bottom opening (15) and a front opening (16), with a pair of spaced wings (17) extending alongside the front opening (16) and holes (18) defined in the wings (17) respectively.

The door (20) is pivotally connected to the helmet (10), preferably at the top wall (13), for opening and closing the front opening (16). More importantly, the door (20) is formed with a lock (21), such as in the type that is opened by a key (not shown) inserted in a keyslot (21) thereof, for the purpose of releasably fastening the door (20) to the helmet (10) when the front opening (16) is closed.

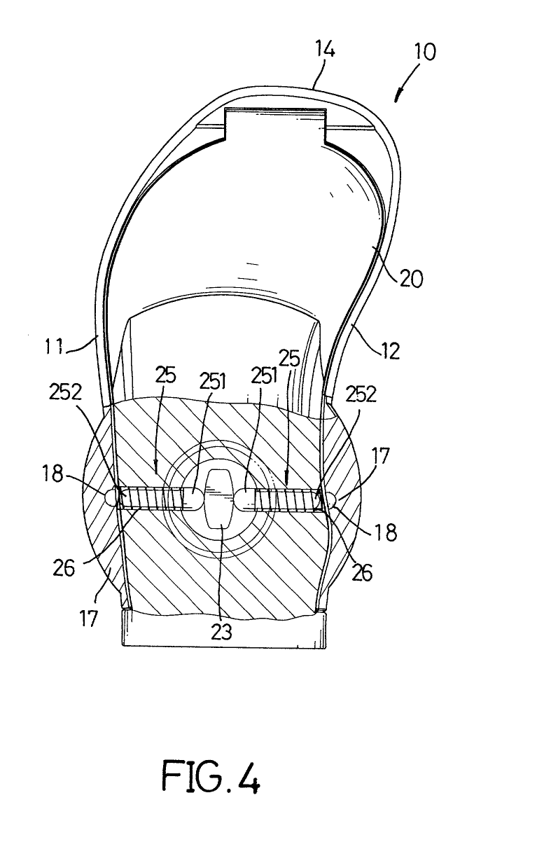

Referring still to FIG. 2 and additionally to FIG. 4, the lock (21) includes a rotary cam (23) adapted to be turned by the key, and a pair of bolts (25) movable along respective passages (24) defined in the door (20). The rotary cam (23), preferably with a substantially oval profile, is contoured to retractably move the bolts (25) into the holes (18) in the wings (17) of the helmet (10), thereby releasably fastening the door (20) to the helmet (10) when the front opening (16) is fully closed.

In the illustrated preferred embodiment, each of the bolts (25) is configured as a shank (252) having an enlarged inner end (251), with a spring (26) mounted around the shank (252) and abutting the enlarged inner end (251) so as to move the bolt (25) from the hole (18) in the associated wing (17) of the helmet (10).

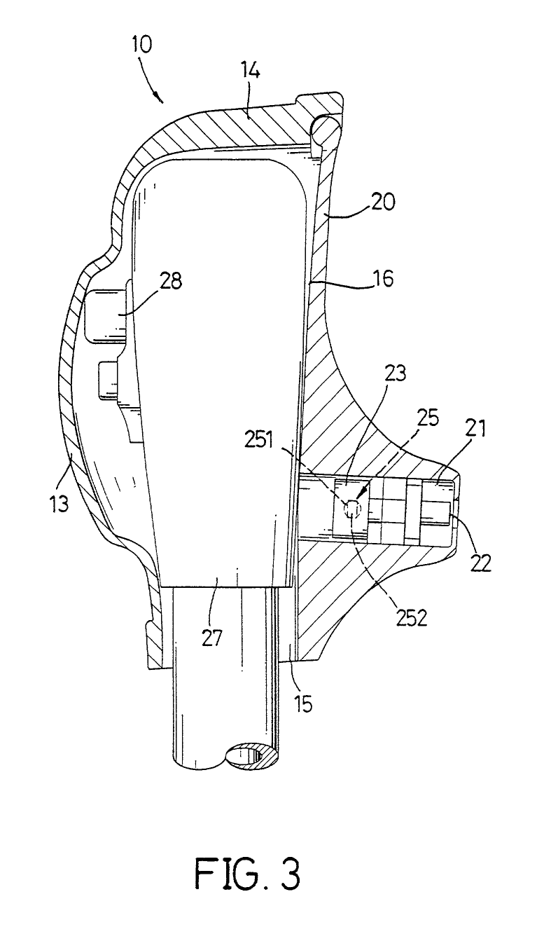

Referring to FIGS. 3, 4 and 5, the lockable restrainer is provided for a gearshift (27) that has a side formed with buttons (28), which, as well known, are required to be pressed down before the gearshift (27) is moved. The side of the gearshift (27) can be brought into the helmet (10) through the front opening (16), with the buttons (28) received in the convex portion of the chamber behind the rear convex wall (13). The front opening (16) is fully closed when the door (20) is shut, which encloses the side with the buttons (28) in the restrainer.

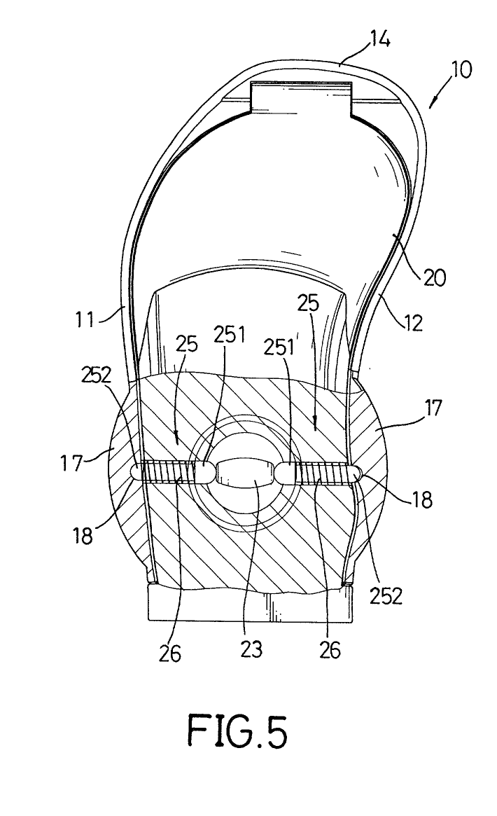

The door (20) can then be fastened to the helmet (10) by inserting the key into the keyslot (22) of the lock (21). With the key turned, the cam (23) will be rotated from its upright position, as shown in FIG. 4, to its horizontal position, as shown in FIG. 5. It is in the horizontal position of the cam (23) that the bolts (25) are moved into the holes (18) in the wings (17) of the helmet (10), securely fastening the door (20) and the helmet (10) together. This prevents the buttons (28) in the restrainer from being pressed by anyone who has no key to open the lock (21).

From the above description, it is noted that the invention has the advantage of taking up a small space, either in use or in storage, within an automobile, since it is associated only with the side of the gearshift (27).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lockable restrainer for a gearshift lever (27) formed with at least one button (28), comprising:
a helmet (10) formed by a pair of rigid sidewalls (11,12), a rigid convex rear wall (13), a rigid top wall (14), a bottom opening (15) and a front opening (16);
said helmet (10) defining therein a chamber having a convex portion behind said rear wall (13), said convex portion of said chamber being dimensioned to receive said button (28) of said gearshift lever (27); and
a door (20) pivotally connected to said helmet (10) for opening and closing said front opening (16), said door (20) being formed with a lock (21) for releasably fastening said door (20) to said helmet (10) after said front opening (16) has been fully closed.

2. The lockable restrainer as claimed in claim 1, wherein said door (20) is pivotally connected to said helmet (10) at said top wall (13).

3. The lockable restrainer as claimed in claim 2, wherein said helmet (10) further has a pair of spaced wings (17) extending alongside said front opening (16) with respective holes (18) defined in said wings (17), and wherein said lock (21) of said door (20) has a pair of bolts (25) adapted to be retractably extended into said holes (18) in said wings (17), thereby releasably fastening said door (20) to said helmet (10) after said front opening (16) has been fully closed.

4. The lockable restrainer as claimed in claim 3, wherein said door (20) defines a pair of passages (24) therein, and wherein said bolts (25) of said lock (21) are adapted to be moved along said passages (24) into and from said holes (18) in said wings (17) of said helmet (10).

5. The lockable restrainer as claimed in claim 4, wherein said lock (21) has a cam (23) contoured to move said bolts (25) into said holes (18)in said wings (17) of said helmet (10) when said cam (23) is turned.

6. The lockable restrainer as claimed in claim 5, wherein said lock (21) further has a pair of springs (26) adapted to move said bolts (25) back from said holes (18) in said wings (17) of said helmet (10).

7. The lockable restrainer as claimed in claim 6, wherein said cam (23) has a substantially oval profile.
